(19) United States
(12) Patent Application Publication
(10) Pub. No.: US 2024/0028569 A1
(43) Pub. Date: Jan. 25, 2024

(54) MANAGING ENTITY LEVEL RELATIONSHIPS IN MASTER DATA MANAGEMENT BASED SYSTEM

(71) Applicant: International Business Machines Corporation, Armonk, NY (US)

(72) Inventors: Abhishek Seth, Deoband (IN); Soma Shekar Naganna, Bangalore (IN); Geetha Sravanthi Pulipaty, Bangalore (IN); Prabhakaran Ramalingam, Bangalore (IN)

(21) Appl. No.: 17/871,040

(22) Filed: Jul. 22, 2022

(51) Int. Cl. G06F 16/215; G06F 16/28; G06F 16/23

(52) U.S. Cl. CPC G06F 16/215; G06F 16/288; G06F 16/2365

(57) ABSTRACT

A computer-implemented method, system and computer program product for managing relationships between entities in master data management based systems. Record level relationships at an entity level are resolved. Furthermore, a unified view of relationships between entities is determined using composite rules on the underlying resolved record level relationships. Additionally, an anchor member for each linked entity is determined, where the entities are linked together based on the determined unified view of relationships between entities. Furthermore, a record transaction involving creating, updating or deleting a record of an entity linked with another entity is received. The relationship between the linked entities is then validated or invalidated based on an impact of the record transaction with the anchor member of one of the linked entities. In this manner, relationships between entities are managed when record transactions involving creating, updating or deleting a record associated with such entities occur.

### TECHNICAL FIELD

The present disclosure relates generally to master data management, and more particularly to managing entity level relationships in a master data management based system.

### BACKGROUND

Master data management is a technology-enabled discipline in which business and information technology work together to ensure the uniformity, accuracy, stewardship, semantic consistency and accountability of the enterprise's official shared master data assets.

### SUMMARY

In one embodiment of the present disclosure, a computer-implemented method for managing relationships between entities in master data management based systems comprises resolving record level relationships at an entity level. The method further comprises determining a unified view of relationships between entities using composite rules on underlying resolved record level relationships. The method additionally comprises determining an anchor member for both a first entity and a second entity being linked together based on the determined unified view of relationships between entities, where the anchor member corresponds to a record out of all records associated with an entity that is most representative of the entity. Furthermore, the method comprises receiving a record transaction involving a creating, updating or deleting of a record of one of the first and second entities. Additionally, the method comprises validating or invaliding a relationship between the first entity and the second entity based on an impact of the record transaction with the anchor member of the first entity or the second entity.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the master data management (MDM) system to manage the relationships between entities when record transactions involving creating, updating or deleting a record associated with such entities occur in accordance with an embodiment of the present disclosure;

FIG. 3 illustrates a relationship between linked entities in accordance with an embodiment of the present disclosure;

FIG. 4 illustrates a record add/update of a member of an entity in which the added/updated member corresponds to the new anchor member for that entity in accordance with an embodiment of the present disclosure;

FIG. 5 illustrates a record add/update of a member of an entity in which the added/updated member does not change the pre-existing anchor member for that entity in accordance with an embodiment of the present disclosure;

FIG. 6 illustrates a record add/update/delete transaction causing an anchor member of an entity to be moved to another entity without being designated as an anchor member in accordance with an embodiment of the present disclosure;

FIG. 7 illustrates a record add/update/delete transaction causing an anchor member of an entity to be moved to another entity with it being designated as an anchor member in accordance with an embodiment of the present disclosure;

FIG. 8 illustrates the entity composition remaining unchanged upon receiving a record update in accordance with an embodiment of the present disclosure;

FIG. 9A illustrates the entity composition prior to an entity split operation in accordance with an embodiment of the present disclosure;

FIG. 9B illustrates the two formed entities after the entity split operation is performed on the entity composition of FIG. 9A in accordance with an embodiment of the present disclosure;

FIGS. 10A-10B illustrate an entity join operation in accordance with an embodiment of the present disclosure;

FIG. 11 illustrates an embodiment of the present disclosure of the hardware configuration of the master data management system which is representative of a hardware environment for practicing the present disclosure;

FIG. 12 is a flowchart of a method for managing the relationships between entities in accordance with an embodiment of the present disclosure;

FIG. 13 is a flowchart of a method for resolving record level relationships at an entity level in accordance with an embodiment of the present disclosure;

FIG. 14 is a flowchart of a method for determining the unified view of the relationships between entities using composite rules on the underlying resolved record level relationships in accordance with an embodiment of the present disclosure;

FIG. 15 is a flowchart of a method for determining anchor members in entities in accordance with an embodiment of the present disclosure;

FIGS. 16A-16B are a flowchart of a method for managing the relationship been entities when record transactions involving creating, updating or deleting a record occur in accordance with an embodiment of the present disclosure; and

FIG. 17 is a flowchart of a method for handling a manual unlink/link rule in accordance with an embodiment of the present disclosure.

### DETAILED DESCRIPTION

As stated in the Background section, master data management is a technology-enabled discipline in which business and information technology work together to ensure the uniformity, accuracy, stewardship, semantic consistency and accountability of the enterprise's official shared master data assets.

Organizations, or groups of organizations, may establish the need for master data management when they hold more than one copy of data about a business entity. Holding more than one copy of this master data inherently means that there is an inefficiency in maintaining a “single version of the truth” across all copies. Unless people, processes and technology are in place to ensure that the data values are kept aligned across all copies, it is almost inevitable that different versions of information about a business entity will be held. This causes inefficiencies in operational data use, and hinders the ability of organizations to report and analyze. At a basic level, master data management seeks to ensure that an organization does not use multiple (potentially inconsistent) versions of the same master data in different parts of its operations, which can occur in large organizations.

Master data management based solutions work with enterprise data (data that is shared by the users of an organization, generally across departments and/or geographic regions), perform indexing (organization of data according to a specific schema or plan) and link data from difference sources, such as CRM®, Experian®, Salesforce®, web portal, etc. As a result, the master data management based system provides a single, trusted 360-degree view into customer, product and location data across the enterprise.

In order to ensure the uniformity, accuracy, stewardship, semantic consistency and accountability of the enterprise's official shared master data assets, master data management systems match record pair data by comparing different record attributes (e.g., name, address, data of birth) from each pair of records to determine if they match and should subsequently be linked based on a series of mathematically derived statistical probabilities and complex weight tables.

A “record,” as used herein, includes information an organization needs to know about a particular person, location, product, supplier, business or other entity. This record is referred to as the surviving record for an entity. A “record” may also be referred to as the master record or golden record. The goal of master data management is the definition of only one master record for each entity that is important to a business. An “entity,” as used herein, refers to the core element that is used for business processes in master data management.

Across the enterprise, there may be many records that relate to a single entity. For example, there may be records for the same customer in purchasing, ordering, fulfillment, marketing, and analysis systems. Furthermore, there may be duplicate records for a customer within the same system. Master data management identifies the records that are related to a single entity and creates or persists an entity with the information available from all records based on composite rules available or selected in the system. All of the records that relate to an entity are referred to as contributors to that entity.

Any type of data that is important to a business and is not transactional in nature has the potential to be a master data entity type. In master data management, the user can create a new entity type or modify an existing entity type through the Entity Definition Editor.

An entity may be defined by three things, namely, attributes, standardizations and clustering criteria. Attributes are the data elements that are used by the entity. For example, a person entity might have first name, last name, address, city, state, postal code, phone number and email address as its attributes.

Standardization refers to the process of conforming the entity to a standard. For example, users can define the ways in which attributes will be cleansed and the match codes that will be generated from them. Clustering can then be performed on standardized fields or match codes rather than raw data. This greatly improves clustering accuracy.

Furthermore, an entity may be defined by clustering criteria. For example, for each entity type, one or more sets of fields that match are selected in order to identify records that belong in the same cluster.

In master data management systems, a relationship could exist among records and/or entities, such as having a relationship between records (record-record relationship), between a record and an entity (record-entity relationship) and between entities (entity-entity relationship).

One of the main aspects of master data management based solutions is managing relationships between parties including individuals, individuals and households, individuals and corporate entities, informal groups and organizations. Understanding relationships between parties and products as well as product hierarchies is critical for enterprises.

A user can manage (create/update/delete) such relationships at the record level or at the entity level that is derived and persisted out of the record level. However, by managing (creating/updating/deleting) relationships at the record level, it may have an effect at the entity level. Currently, there is not a master data management based system for assessing such an effect at the entity level. That is, there is not currently a master data management based system for managing the relationships between entities (entity level relationships) when record transactions involving creating, updating or deleting a record associated with such entities occur.

The embodiments of the present disclosure provide a means for managing the relationships between entities when record transactions involving creating, updating or deleting a record associated with such entities occur by utilizing an “anchor” member of the entities in order to validate or invalidate the relationships between such entities as discussed further below.

In some embodiments of the present disclosure, the present disclosure comprises a computer-implemented method, system and computer program product for managing relationships between entities in master data management based systems. In one embodiment of the present disclosure, record level relationships at an entity level are resolved. “Resolving,” as used herein, refers to firmly determining the relationships among records associated with entities at the entity level. A “record,” as used herein, refers to information an organization needs to know about a particular person, location, product, supplier, business or other entity. An “entity,” as used herein, is the core element that is used for business processes in master data management. “Record level relationships at an entity level,” as used herein, refers to the relationships among records between entities. Furthermore, a unified view of relationships between entities is determined using composite rules on the underlying resolved record level relationships. “Composite rules,” as used herein, refer to the rules that determine which attributes (e.g., name, address) get persisted at the entity level. That is, composite rules determine which record-record relationships are persisted as entity-entity relationships. Additionally, an “anchor member” for each linked entity (e.g., first and second entities are linked together) is determined, where the entities are linked together based on the determined unified view of relationships between entities. An “anchor member,” as used herein, refers to the member (e.g., record) of the entity that is most representative of the entity. A record transaction involving creating, updating or deleting a record of an entity (e.g., first entity) linked with another entity (e.g., second entity) is received. The relationship between the linked entities is then validated or invalidated based on an impact of the record transaction with the anchor member of one of the linked entities. In this manner, relationships between entities are managed when record transactions involving creating, updating or deleting a record associated with such entities occur.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

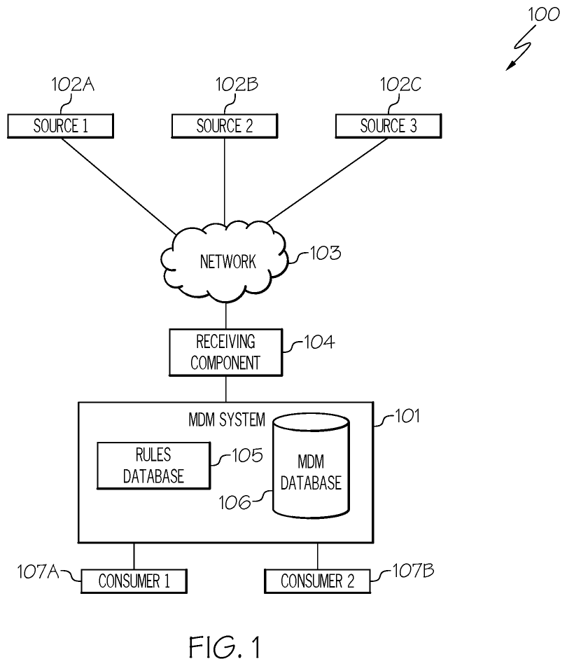

Referring now to the Figures in detail, FIG. 1 illustrates an embodiment of the present disclosure of a communication system 100 for practicing the principles of the present disclosure. Communication system 100 includes a master data management (MDM) system 101. A person skilled in the art will understand that there can be a number of possible structures for organizing MDM system 101. For example, a database of master data may be maintained as a separate entity in MDM system 101. Alternatively, MDM system 101 may provide a view to a collection of source system databases, or the system may be a hybrid comprising some combination of the two. FIG. 1 will be described with reference to a system in which a separate database of master data is maintained by MDM system 101.

FIG. 1 further illustrates source systems 102A-102C (labeled as “Source 1,” “Source 2,” and “Source 3,” respectively, in FIG. 1) connected to MDM system 101 via a network 103 and a receiving component 104. Source systems 102A-102C may collectively or individually be referred to as source systems 102 or source system 102, respectively.

A source system 102, as used herein, refers to a source (e.g., CRM®, Experian®, Salesforce®, web portal, etc.) of data (e.g., enterprise data). Such data among various source systems 102 are linked together by MDM system 101 in order to provide a single, trusted 360-degree view into customer, product and location data across the enterprise.

In one embodiment, source systems 102 may represent different areas of an organization's functioning. For example, each of the source systems 102A-102C may be a sales system, a customer database system, and a payroll system. In one embodiment, source systems 102 continually generate new data. For example, source system 102A may be a sales system which generates data relating to a sale. In addition to data being handled within source system 102A, the data relating to the sale can be transmitted to receiving component 104 for subsequent operations performed by MDM system 101.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

In one embodiment, receiving component 104 receives data from each of the source systems 102, such as source systems 102A-102C, and performs an analysis to identify data which may be relevant to the organization's master data collection. For example, receiving component 104 may include an application program, a constituent component of a larger data processing system, or a component of MDM system 101. In one embodiment, receiving component 104 further processes the received data. For example, receiving component 104 may map the received data to a format compatible with the data format of MDM system 101. In this embodiment, receiving component 104 transmits processed data to MDM system 101.

In one embodiment, MDM system 101 includes a rules database 105 that includes a collection of policies and rules which have been determined to be appropriate for application to the organization's master data. Such policies and rules describe the types of data to be recorded as master data, the form of the data, and the actions to be performed upon the data. The policies and rules may be set (e.g., defined) based on a data governance strategy proposed by a data governance council of individuals who understand the organization's master data requirements.

In one embodiment, rules database 105 stores “composite rules” which provide the user the ability to specify various criteria (e.g., source priority, most frequent record at the entity level, most recent record to be available at the entity level) for determining a unified view of the relationships between entities.

In one embodiment, MDM system 101 also includes a MDM database 106 for storing master data. In one embodiment, MDM system 101 compares received data with the master data in MDM database 106, and applies appropriate rules specified in rules database 105. With the application of appropriate rules of rules database 105, MDM system 101 determines a unified view of the relationships between entities.

For example, a rule may specify the criteria of similarity which determines whether a record matches another record to a sufficient degree of similarity that said records are deemed to be “duplicated.” In one embodiment, if the similarity criteria is met, MDM system 101 can automatically confirm the match and associate the new data in MDM system 101 with the master data record of MDM database 106. For example, MDM system 101 can confirm the match and associate the new data by updating an address record in the master data.

Furthermore, in one embodiment, MDM database 106 stores “confidence scores” for the records. A “confidence score,” as used herein, refers to the score for evaluating the relationships present at the records level. In one embodiment, such a score is based on the record including user-designated information (e.g., information about a particular person, location, product, supplier, business or other entity, attributes, etc.) stored in the record. In one embodiment, the higher the value of the confidence score, the greater the extent that the user-designated information is present in the record. In one embodiment, such user-designated information is provided by the administrator or expert.

System 100 further includes master data consuming systems of an organization, such as consumers 107A-107B (identified as “Consumer 1,” and “Consumer 2,” respectively, in FIG. 1). Consumers 107A-107B may collectively or individually be referred to as consumers 107 or consumer 107, respectively. “Consumers” 107, as used herein, refer to the systems of the organization which require access to the data records of the organization's master data. It will be apparent that any number of consumers 107 may receive master data from MDM database 106 of MDM system 101. It will be apparent also that each consumer 107 may include the same system as one of the source systems 102A-102C.

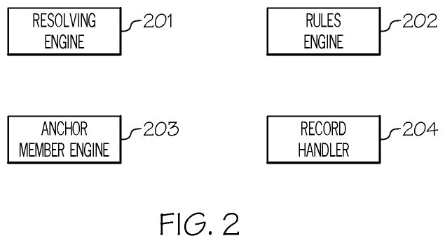

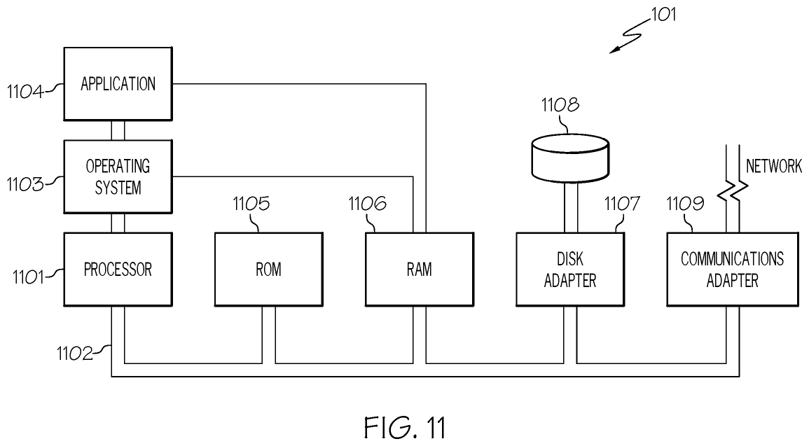

A description of the software components of MDM system 101 used for managing the relationships between entities when record transactions involving creating, updating or deleting a record associated with such entities occur is provided below in connection with FIG. 2. A description of the hardware configuration of master data management system 101 is provided further below in connection with FIG. 11.

System 100 is not to be limited in scope to any one particular network architecture. System 100 may include any number of MDM systems 101, sources 102, networks 103, receiving components 104 and consumers 107. For example, system 100 may include a network, such as network 103, connecting MDM system 101 and consumers 107. In another example, system 100 may include a network, such as network 103, connecting MDM system 101 and receiving component 104.

A discussion regarding the software components used by MDM system 101 for managing the relationships between entities when record transactions involving creating, updating or deleting a record associated with such entities occur is provided below in connection with FIG. 2.

FIG. 2 is a diagram of the software components used by MDM system 101 (FIG. 1) to manage the relationships between entities when record transactions involving creating, updating or deleting a record associated with such entities occur in accordance with an embodiment of the present disclosure.

Referring to FIG. 2, in conjunction with FIG. 1, MDM system 101 includes a resolving engine 201 configured to resolve record level relationships at an entity level. That is, resolving engine 201 is configured to resolve or determine the relationships among records associated with entities at the entity level that have been previously defined, including user-defined relationships and system-defined relationships.

“Resolving,” as used herein, refers to firmly determining the relationships among records associated with entities at the entity level.

A “record,” as used herein, refers to information an organization needs to know about a particular person, location, product, supplier, business or other entity. This record is also referred to as the surviving record for an entity. A “record” may also be referred to as the master record or golden record.

An “entity,” as used herein, is the core element that is used for business processes in master data management.

“Record level relationships at an entity level,” as used herein, refers to the relationships among records between entities.

In one embodiment, resolving performed by resolving engine 201 may involve resolving the relationships between the records of an entity based on determining whether the records are duplicated. In one embodiment, resolving engine 201 identifies duplicate records using matching functionality (“matching mode” process). In one embodiment, the matching mode process involves comparing the attribute data of the records (e.g., name, address, date of birth) to determine if they are substantially similar to warrant a “match” based on mathematically derived statistical probabilities and complex weight tables. In one embodiment, resolving engine 201 utilizes InfoSphere® master data management to perform such matching.

In one embodiment, resolving engine 201 finds duplicate records using rules and matching strategies based on certain key fields. In one embodiment, duplicate records are based on “importance scores” assigned to various fields (e.g., first name, last name, place of birth) which correspond to the level of importance in using such a field to identify a duplicate record. In one embodiment, such scores are assigned to various fields by an expert. In one embodiment, resolving engine 201 assigns a total score for each record based on the similarity of the field values with respect to the field values of the record in question along with weighting such a score based on the importance scores assigned to the fields. The higher the score, the greater the degree that the records are similar. In one embodiment, a “duplicate” record is determined when the assigned score exceeds a threshold value.

In one embodiment, resolving engine 201 resolves the relationships among the records associated with entities at the entity level based on the entity type. For example, an entity may correspond to an identity type or an association type. An identity type allows for distinction between the way members (records associated with an entity) are viewed and linked. For such an entity type, the relationships among the records within an entity would be collapsed.

For an association type of entity, all the relationships among the records within the entity would remain valid.

Examples of software tools utilized by resolving engine 201 to perform the functions discussed above include, but not limited to, Boomi®, TIBCO EBX®, EnterWorks® Enable, Akeneo® PIM, Syndigo®, Oracle® MDM, Talend® MDM, Profisee®, etc.

MDM system 101 further includes a rules engine 202 configured to determine a unified view of the relationships between entities using composite rules on the underlying resolved record level relationships. In one embodiment, such composite rules are stored in rules database 105.

“Composite rules,” as used herein, refer to the rules that determine which attributes (e.g., name, address) get persisted or are available at the entity level. That is, composite rules determine which record-record relationships are persisted as entity-entity relationships.

In one embodiment, such composite rules are determined by an administrator or an expert.

In one embodiment, rules engine 202 determines a unified view of relationships between entities by selecting records from entities based on confidence scores. In this manner, rules engine 202 creates entity level relationships based on the composition of the records' relationship data. As discussed above, a “confidence score,” as used herein, refers to the score for evaluating the relationships present at the records level. In one embodiment, such a score is based on the record including user-designated information (e.g., information about a particular person, location, product, supplier, business or other entity, attributes, etc.) stored in the record. In one embodiment, the higher the value of the confidence score, the greater the extent that the user-designated information is present in the record. In one embodiment, such user-designated information is provided by the administrator or expert.

In one embodiment, rules engine 202 assigns the confidence score to the records based on the extent that the record contains the user-designated information using a software tool, such as InfoSphere® master data management.

In one embodiment, records from various entities at the entity level are selected based on the confidence scores exceeding a threshold level, which may be user-designated. For such selected records, rules engine 202, in one embodiment, identifies the cross-relationships from the records in one entity to the records in the other entity thereby establishing entity level relationships. That is, rules engine 202 identifies the cross-relationships from the records related or associated with entity #1 to the records related or associated with entity #2 thereby establishing entity level relationships between entities #1 and #2. Such cross-relationships may involve matching attribute values, such as matching first name, last name, date of birth, etc.

After identifying such cross-relationships, rules engine 202 identifies a number of relationships applicable at the entity level based on the identified cross-relationships. For example, rules engine 202 may have identified that records A, B, C, D and E have a relationship at the entity level based on each of these records having cross-relationships that involve a certain user-designated number of matching attribute values. While the foregoing discusses record/record relationships, it is noted that the principles of the present disclosure may also be used to identify relationships involving record/entity and entity/entity.

Furthermore, in one embodiment, rules engine 202 identifies an additional number of record level relationships which will be applicable at the entity level based on composite rules. Such composite rules provide the user the ability to specify criteria (e.g., source priority, most frequent record at the entity level, most recent record to be available at the entity level) for compositing the relationship data and making them available at the entity level. Hence, rules engine 202 determines if there are any records that meet such criteria (e.g., most recent record to be available at the entity level) that have not previously been identified as having a relationship with another record in a different entity. While the foregoing discusses record/record relationships, it is noted that the principles of the present disclosure may also be used to identify relationships involving record/entity and entity/entity.

MDM system 101 additionally includes an anchor member engine 203 configured to determine the anchor members of the entities. An “anchor member,” as used herein, refers to the member (e.g., record) of the entity that is most representative of the entity.

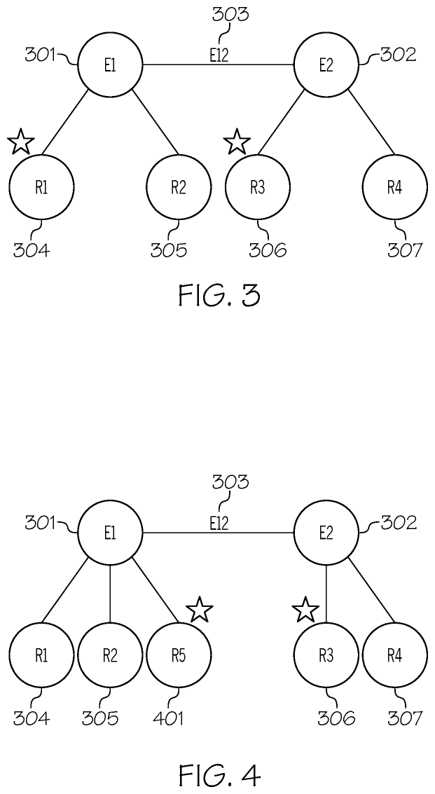

In one embodiment, anchor member engine 203 determines the anchor member for each entity that is linked together based on the determined unified view of the relationships between the entities. For example, in one embodiment, entities may be related together based on having a record/record relationship between the two entities as discussed above. In such related entities, the anchor member for each of these entities is determined by anchor member engine 203 as illustrated in FIG. 3.

FIG. 3 illustrates a relationship between linked entities in accordance with an embodiment of the present disclosure.

Referring to FIG. 3, entity #1 (identified as “E1”) 301 is linked with entity #2 (identified as “E2”). Such entities are said to have a relationship as shown by label E12 303 in FIG. 3.

Furthermore, as shown in FIG. 3, the members of E1 301 include records, R1 304 and R2 305. Additionally, as shown in FIG. 3, the members of E2 302 include records, R3 306 and R4 307.

As previously discussed, anchor member engine 203 is configured to identify one of the members of each linked entity, such as identifying the anchor member for entity E1 301 and for entity E2 302.

In one embodiment, anchor member engine 203 identifies the “center member” of the entity corresponding to the record associated with the entity with the highest confidence score (discussed above). Such a member corresponds to the record having the most information.

In one embodiment, anchor member engine 203 identifies the “closest member” of the entity corresponding to the record with the attribute values that match most closely to the attribute values of the entity. In one embodiment, such a determination is performing using matching functionality (“matching mode” process). In one embodiment, the matching mode process involves comparing the attribute data of the members (e.g., name, address, date of birth) with the attribute data of the entity to determine if they are substantially similar to warrant a “match” based on mathematically derived statistical probabilities and complex weight tables. In one embodiment, anchor member engine 203 utilizes InfoSphere® master data management to perform such matching.

In one embodiment, anchor member engine 203 selects either the center member or the closest member of the entity as corresponding to the “anchor member” of the entity. For example, referring to FIG. 3, members 304 and 306 correspond to the anchor members of entities E1 301 and E2 302, respectively, as identified by the “*” placed next to the members in FIG. 3.

Returning to FIG. 2, MDM system 101 further includes a record handler 204 for determining the impact on the entities and the entity level relationships upon a record add/update/delete transaction.

In one embodiment, upon MDM system 101 receiving a record add/update/delete transaction from receiving component 104, record handler 204 determines which of the following impacts occurred on the existing entities: (1) entity composition remains unchanged; (2) entity splits into multiple entities; and (3) entities join to form a single entity.

In one embodiment, record handler 204 validates or invalidates a relationship between entities based on the record transaction (e.g., create/update/delete a record) impact with the anchor member of one of these entities as discussed below.

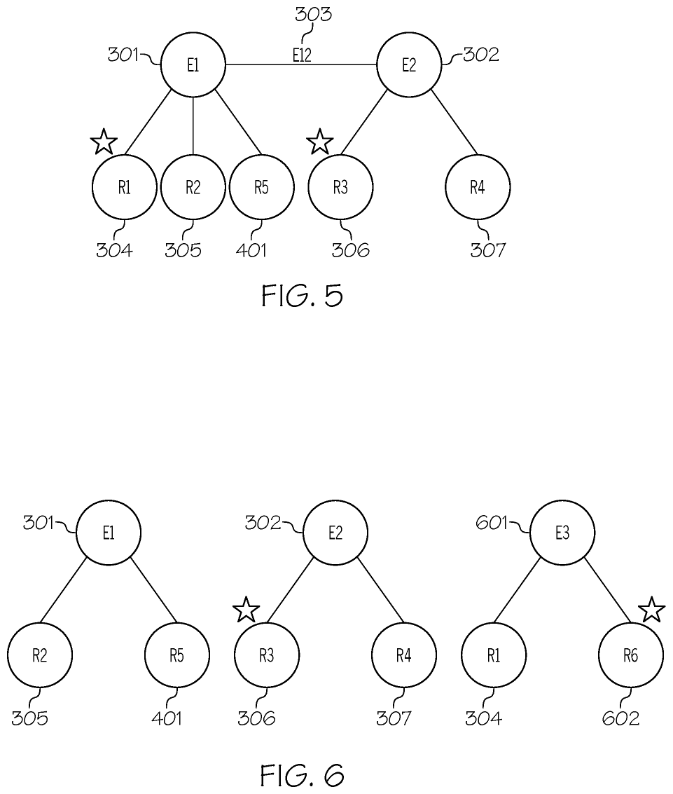

In one embodiment, record handler 204 determines that the relationship between the linked entities remains valid involving a record add/update when the newly added/updated record for the entity is the new anchor member for that entity or when the newly added/updated record for the entity does not change the pre-existing anchor member for that entity as discussed below in connection with FIGS. 4 and 5.

FIG. 4 illustrates a record add/update of a member of an entity in which the added/updated member corresponds to the new anchor member for that entity in accordance with an embodiment of the present disclosure.

Referring to FIG. 4, in conjunction with FIG. 3, record R5 401 has been added as a member of E1 301 and was made the anchor member by anchor member engine 203 as indicated by the “*” placed next to record R5 401. In such a scenario, record handler 204 determines that the relationship E12 303 is still valid. Furthermore, it is noted that record handler 204 would also validate the relationship E12 303 if the record was added as a member of E2 302 and was made the anchor member of E2 302.

Referring now to FIG. 5, FIG. 5 illustrates a record add/update of a member of an entity in which the added/updated member does not change the pre-existing anchor member for that entity in accordance with an embodiment of the present disclosure.

As shown in FIG. 5, in conjunction with FIGS. 3 and 4, newly added record R5 401 to entity E1 301 was not made the anchor member of entity E1 301. This is contrary to record R5 401 being made the anchor member of E1 301 as shown in FIG. 4. Instead, as shown in FIG. 5, record R1 304 remains the anchor member for entity E1 301. As a result, record handler 204 determines that the relationship E12 303 is still valid. Furthermore, it is noted that record handler 204 would also validate the relationship E12 303 if the record was added as a member of E2 302 and the original anchor member of E2 302 was still the anchor member of E2 302.

However, if a record add/update/delete transaction caused the anchor member of an entity to move to another entity and is not an anchor member of that entity, then the relationship between such originally linked entities is invalid as discussed below in connection with FIG. 6.

FIG. 6 illustrates a record add/update/delete transaction causing an anchor member of an entity to be moved to another entity without being designated as an anchor member in accordance with an embodiment of the present disclosure.

Referring to FIG. 6 in conjunction with FIGS. 3 and 4, record R5 401 has been added as a member of E1 301. Furthermore, as a result of the record add/update/delete transaction, record R1 304 becomes a member of entity E3 601, which has member R6 602 as the anchor member for entity E3 601 as indicated by the “*” placed next to record R6 602. As a result of such a scenario, the relationship E12 303 is no longer valid.

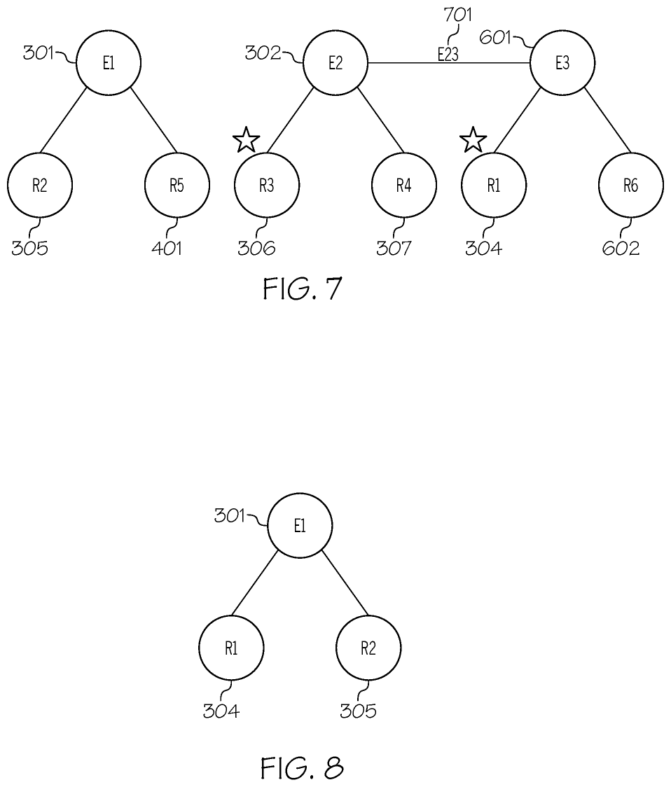

If, however, there is a record add/update/delete transaction that causes an anchor member of an entity to be moved to another entity with it being designated as an anchor member, then the relationship created between the previous linked entities is moved as discussed below in connection with FIG. 7.

FIG. 7 illustrates a record add/update/delete transaction causing an anchor member of an entity to be moved to another entity with it being designated as an anchor member in accordance with an embodiment of the present disclosure.

Referring to FIG. 7 in conjunction with FIGS. 3, 4 and 6, record R5 401 has been added as a member of E1 301. Furthermore, as a result of the record add/update/delete transaction, record R1 304 becomes a member of entity E3 601 in which record R1 304 is designated as the anchor member of entity E3 601 by anchor member engine 203 as shown by the “**” placed next to record R1 304. As a result of such a scenario, the relationship E12 303 is now moved between entities E2 302 and E3 601 as shown in FIG. 7 by relationship E23 701.

Furthermore, as discussed above, upon MDM system 101 receiving a record add/update/delete transaction from receiving component 104, record handler 204 determines which of the following impacts occurred on the existing entities: (1) entity composition remains unchanged; (2) entity splits into multiple entities; and (3) entities join to form a single entity.

Referring now to FIG. 8, in conjunction with FIG. 3, FIG. 8 illustrates the entity composition remaining unchanged upon receiving a record update in accordance with an embodiment of the present disclosure.

As shown in FIG. 8, record R1 304 or record R2 305 is updated resulting in no changed to entity E1 301.

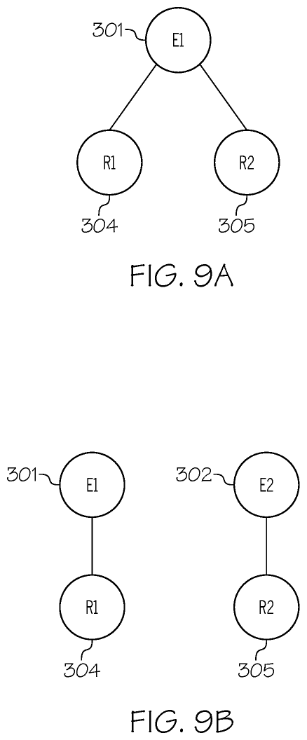

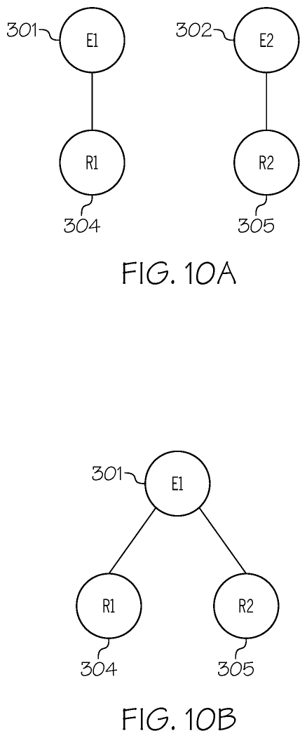

Alternatively, a transaction, such as an update to record R1 304 or record R2 305 or receipt of a manual unlink rule to unlink the records of an entity, may cause record handler 204 to perform an entity split operation as discussed below in connection with FIGS. 9A-9B.

FIG. 9A illustrates the entity composition prior to an entity split operation in accordance with an embodiment of the present disclosure. FIG. 9B illustrates the two formed entities after the entity split operation is performed on the entity composition of FIG. 9A in accordance with an embodiment of the present disclosure.

Referring to FIGS. 9A and 9B, in conjunction with FIGS. 1, 3 and 8, there is an update to record R1 304 or to record R2 305 or MDM system 101 receives a manual unlink rule from receiving component 104 resulting in the entity composition as shown in FIG. 9A being split forming entities E1 301 and E2 302, with record R1 304 being a member of entity E1 301 and record R2 305 being a member of entity E2 302 as shown in FIG. 9B.

In one embodiment, a manual unlink rule corresponds to a rule to hold records apart from both being members of the same entity. Such a manual unlink rule may be issued via REST API or Java® API. In one embodiment, such a rule may be issued by an administrator or an expert.

Conversely, a transaction, such as an update to record R1 304 or record R2 305 or receipt of a manual link rule to link the records of an entity, may cause record handler 204 to perform an entity join operation as discussed below in connection with FIGS. 10A-10B.

FIGS. 10A-10B illustrate an entity join operation in accordance with an embodiment of the present disclosure.

Referring to FIGS. 10A and 10B, in conjunction with FIGS. 1, 3 and 9A-9B, there is an update to record R1 304 or to record R2 305 or MDM system 101 receives a manual link rule from receiving component 104 resulting in the entity composition as shown in FIG. 10A (entity E1 301 having member record R1 304 and entity E2 302 having member record R2 305) being joined to form entity E1 301 with records R1 304 and R2 305 being members of the newly joined entity 301 as shown in FIG. 10B.

In one embodiment, a manual link rule corresponds to a rule to hold records together to become members of the same entity. Such a manual link rule may be issued via REST API or Java® API. In one embodiment, such a rule may be issued by an administrator or an expert.

A further description of these and other functions is provided below in connection with the discussion of the method for managing relationships between entities when record transactions involving creating, updating or deleting a record associated with such entities occur.

Prior to the discussion of the method for managing relationships between entities when record transactions involving creating, updating or deleting a record associated with such entities occur, a description of the hardware configuration of master data management system 101 (FIG. 1) is provided below in connection with FIG. 11.

Referring now to FIG. 11, FIG. 11 illustrates an embodiment of the present disclosure of the hardware configuration of master data management system 101 (FIG. 1) which is representative of a hardware environment for practicing the present disclosure.

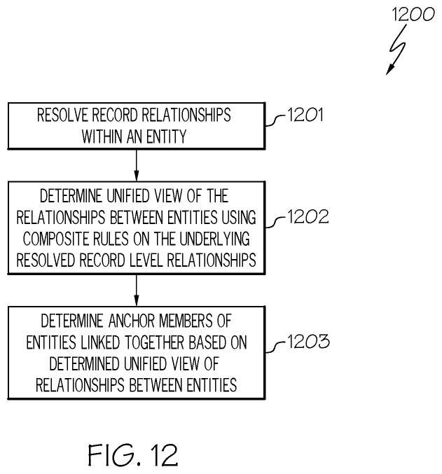

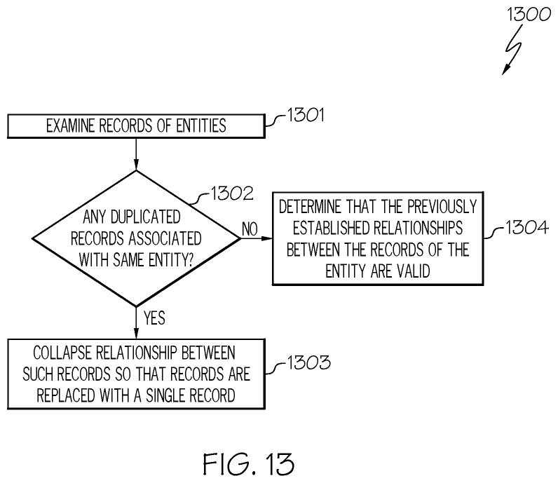

Master data management system 101 has a processor 1101 connected to various other components by system bus 1102. An operating system 1103 runs on processor 1101 and provides control and coordinates the functions of the various components of FIG. 11. An application 1104 in accordance with the principles of the present disclosure runs in conjunction with operating system 1103 and provides calls to operating system 1103 where the calls implement the various functions or services to be performed by application 1104. Application 1104 may include, for example, resolving engine 201 (FIG. 2), rules engine 202 (FIG. 2), anchor member engine 203 (FIG. 2) and record handler 204 (FIG. 2). Furthermore, application 1104 may include, for example, a program for managing relationships between entities when record transactions involving creating, updating or deleting a record associated with such entities occur, as discussed further below in connection with FIGS. 12-15, 16A-16B and 17.

Referring again to FIG. 11, read-only memory (“ROM”) 1105 is connected to system bus 1102 and includes a basic input/output system (“BIOS”) that controls certain basic functions of master data management system 101. Random access memory (“RAM”) 1106 and disk adapter 1107 are also connected to system bus 1102. It should be noted that software components including operating system 1103 and application 1104 may be loaded into RAM 1106, which may be master data management system's 101 main memory for execution. Disk adapter 1107 may be an integrated drive electronics (“IDE”) adapter that communicates with a disk unit 1108, e.g., disk drive. It is noted that the program for managing relationships between entities when record transactions involving creating, updating or deleting a record associated with such entities occur, as discussed further below in connection with FIGS. 12-15, 16A-16B and 17, may reside in disk unit 1108 or in application 1104.

Master data management system 101 may further include a communications adapter 1109 connected to bus 1102. Communications adapter 1109 interconnects bus 1102 with an outside network (e.g., a network, such as network 103 of FIG. 1) to communicate with other devices.

In one embodiment, application 1104 of master data management system 101 includes the software components of resolving engine 201, rules engine 202, anchor member engine 203 and record handler 204. In one embodiment, such components may be implemented in hardware, where such hardware components would be connected to bus 1102. The functions discussed above performed by such components are not generic computer functions. As a result, master data management system 101 is a particular machine that is the result of implementing specific, non-generic computer functions.

In one embodiment, the functionality of such software components (e.g., resolving engine 201, rules engine 202, anchor member engine 203 and record handler 204) of master data management system 101, including the functionality for managing relationships between entities when record transactions involving creating, updating or deleting a record associated with such entities occur, may be embodied in an application specific integrated circuit.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, in master data management systems, a relationship could exist among records and/or entities, such as having a relationship between records (record-record relationship), between a record and an entity (record-entity relationship) and between entities (entity-entity relationship). One of the main aspects of master data management based solutions is managing relationships between parties including individuals, individuals and households, individuals and corporate entities, informal groups and organizations. Understanding relationships between parties and products as well as product hierarchies is critical for enterprises. A user can manage (create/update/delete) such relationships at the record level or at the entity level that is derived and persisted out of the record level. However, by managing (creating/updating/deleting) relationships at the record level, it may have an effect at the entity level. Currently, there is not a master data management based system for assessing such an effect at the entity level. That is, there is not currently a master data management based system for managing the relationships between entities (entity level relationships) as a result of create, update or delete transactions on the records associated with such entities.

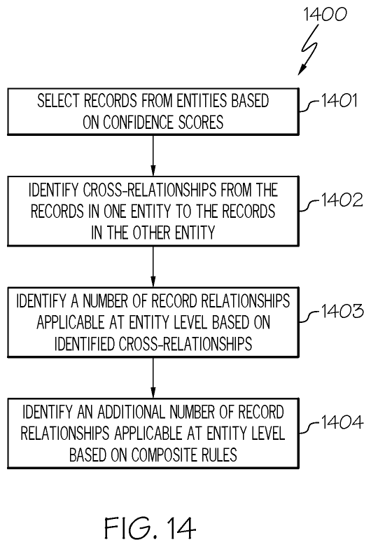

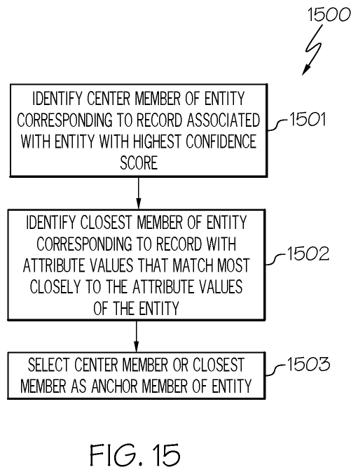

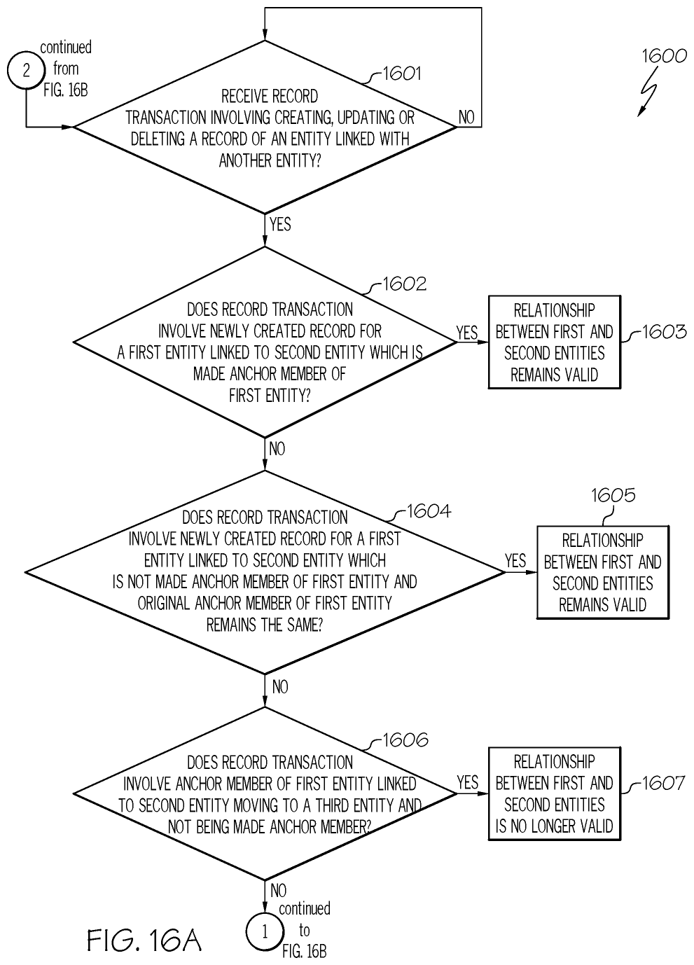

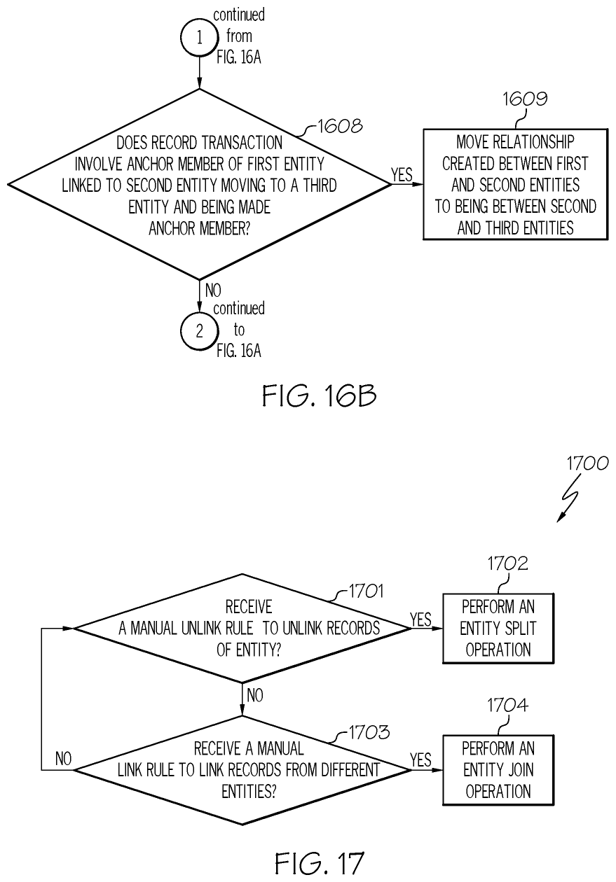

The embodiments of the present disclosure provide a means for managing the relationships between entities when record transactions involving creating, updating or deleting a record associated with such entities occur by utilizing an “anchor” member of the entities in order to validate or invalidate relationships between entities as discussed below in connection with FIGS. 12-15, 16A-16B and 17. FIG. 12 is a flowchart of a method for managing the relationships between entities. FIG. 13 is a flowchart of a method for resolving record level relationships at an entity level. FIG. 14 is a flowchart of a method for determining the unified view of the relationships between entities using composite rules on the underlying resolved record level relationships. FIG. 15 is a flowchart of a method for determining anchor members in entities. FIGS. 16A-16B are a flowchart of a method for managing the relationship been entities when record transactions involving creating, updating or deleting a record occur. FIG. 17 is a flowchart of a method for handling a manual unlink/link rule.

As stated above, FIG. 12 is a flowchart of a method 1200 for managing the relationships between entities in accordance with an embodiment of the present disclosure.

Referring to FIG. 12, in conjunction with FIGS. 1-11, in operation 1201, resolving engine 201 of MDM system 101 resolves record relationships within an entity. That is, resolving engine 201 determines the relationships among records associated with entities at the entity level.

As stated above, “resolving,” as used herein, refers to firmly determining the relationships among records associated with entities at the entity level.

A “record,” as used herein, refers to information an organization needs to know about a particular person, location, product, supplier, business or other entity. This record is also referred to as the surviving record for an entity. A “record” may also be referred to as the master record or golden record.

An “entity,” as used herein, is the core element that is used for business processes in master data management.

“Record level relationships at an entity level,” as used herein, refers to the relationships among records between entities.

A discussion regarding resolving record relationships within an entity is provided below in connection with FIG. 13.

FIG. 13 is a flowchart of a method 1300 for resolving record level relationships at an entity level in accordance with an embodiment of the present disclosure.

Referring to FIG. 13, in conjunction with FIGS. 1-12, in operation 1301, resolving engine 201 of MDM system 101 examines the records of the entities. As previously discussed, there may be several records (e.g., records 304, 305) that relate to an entity (e.g., entity 301). Such records may be examined, such as the records' attribute values, as discussed below to determine duplicate records.

In one embodiment, such examined records have relationships that have been previously defined, including user-defined relationships and system-defined relationships.

In operation 1302, resolving engine 201 of MDM system 101 determines whether there are any records associated with the same entity, where such records are duplicated.

As discussed above, in one embodiment, resolving performed by resolving engine 201 may involve determining the relationship between the records of an entity based on determining whether the records are duplicated. In one embodiment, resolving engine 201 identifies duplicate records using matching functionality (“matching mode” process). In one embodiment, the matching mode process involves comparing the attribute data of the records (e.g., name, address, date of birth) to determine if they are substantially similar to warrant a “match” based on mathematically derived statistical probabilities and complex weight tables. In one embodiment, resolving engine 201 utilizes InfoSphere® master data management to perform such matching.

In one embodiment, resolving engine 201 finds duplicate records using rules and matching strategies based on certain key fields. In one embodiment, duplicate records are based on “importance scores” assigned to various fields (e.g., first name, last name, place of birth) which correspond to the level of importance in using such a field to identify a duplicate record. In one embodiment, such scores are assigned to various fields by an expert. In one embodiment, resolving engine 201 assigns a total score for each record based on the similarity of the field values with respect to the field values of the record in question along with weighting such a score based on the importance scores assigned to the fields. The higher the score, the greater the degree that the records are similar. In one embodiment, a “duplicate” record is determined when the assigned score exceeds a threshold value.

Examples of software tools utilized by resolving engine 201 to perform the functions discussed above include, but not limited to, Boomi®, TIBCO EBX®, EnterWorks® Enable, Akeneo® PIM, Syndigo®, Oracle® MDM, Talend® MDM, Profisee®, etc.

If resolving engine 201 determines that there are records associated with the same entity, where such records are duplicated, then, in operation 1303, resolving engine 201 of MDM system 101 collapses the relationship between such records so that the records are replaced with a single record.

If, however, resolving engine 201 does not identify any duplicated records associated with the same entity, then, in operation 1304, resolving engine 201 of MDM system 101 determines that the previously established relationships between the records of the entity are valid.

Returning now to FIG. 12, in conjunction with FIGS. 1-11, in operation 1202, rules engine 202 of MDM system 101 determines a unified view of the relationships between entities using composite rules on the underlying resolved record level relationships. In one embodiment, such composite rules are stored in rules database 105.

As stated above, “composite rules,” as used herein, refer to the rules that determine which attributes (e.g., name, address) get persisted at the entity level. That is, composite rules determine which record-record relationships are persisted as entity-entity relationships.

In one embodiment, such composite rules provide the user the ability to specify criteria (e.g., source priority, most frequent record at the entity level, most recent record to be available at the entity level) for determining which records will be available at the entity level.

In one embodiment, such composite rules are determined by an administrator or an expert.

A discussion regarding determining a unified view of the relationships between entities using composite rules on the underlying resolved record level relationships is provided below in connection with FIG. 14.

FIG. 14 is a flowchart of a method 1400 for determining the unified view of the relationships between entities using composite rules on the underlying resolved record level relationships in accordance with an embodiment of the present disclosure.

Referring now to FIG. 14, in conjunction with FIGS. 1-12, in operation 1401, rules engine 202 of MDM system 101 selects records from entities based on confidence scores.

As discussed above, a “confidence score,” as used herein, refers to the score for evaluating the relationships present at the records level. In one embodiment, such a score is based on the record including user-designated information (e.g., information about a particular person, location, product, supplier, business or other entity, attributes, etc.) stored in the record. In one embodiment, the higher the value of the confidence score, the greater the extent that the user-designated information is present in the record. In one embodiment, such user-designated information is provided by the administrator or expert.

In one embodiment, rules engine 202 assigns the confidence score to the records based on the extent that the record contains the user-designated information using a software tool, such as InfoSphere® master data management.

In one embodiment, records from various entities at the entity level are selected based on the confidence scores exceeding a threshold level, which may be user-designated.

In operation 1402, rules engine 202 of MDM system 101 identifies the cross-relationships from the records in one entity to the records in the other entity thereby establishing entity level relationships. That is, rules engine 202 identifies the cross-relationships from the records related or associated with entity #1 to the records related or associated with entity #2 thereby establishing entity level relationships between entities #1 and #2. Such cross-relationships may involve matching attribute values, such as matching first name, last name, date of birth, etc.

In operation 1403, after identifying such cross-relationships, rules engine 202 of MDM system 101 identifies a number (n) of record relationships applicable at the entity level based on the identified cross-relationships. For example, rules engine 202 may have identified that records A, B, C, D and E have a relationship at the entity level based on each of these records having cross-relationships that involve a certain user-designated number of matching attribute values. While the foregoing discusses record/record relationships, it is noted that the principles of the present disclosure may also be used to identify relationships involving record/entity and entity/entity.

In operation 1404, rules engine 202 of MDM system 101 identifies an additional number of record relationships applicable at the entity level based on composite rules.

As previously discussed, such composite rules provide the user the ability to specify criteria (e.g., source priority, most frequent record at the entity level, most recent record to be available at the entity level) for compositing the relationship data and making them available at the entity level. Hence, rules engine 202 determines if there are any records that meet such criteria (e.g., most recent record to be available at the entity level) that have not previously been identified as having a relationship with another record in a different entity. While the foregoing discusses record/record relationships, it is noted that the principles of the present disclosure may also be used to identify relationships involving record/entity and entity/entity.

Returning to FIG. 12, in conjunction with FIGS. 1-11, in operation 1203, anchor member engine 203 of MDM system 101 determines the anchor member for each entity that is linked together based on the determined unified view of the relationships between the entities. An “anchor member,” as used herein, refers to the member (e.g., record) of the entity that is most representative of the entity.

For example, in one embodiment, entities may be related together based on having a record/record relationship between the two entities as discussed above. In such related entities, the anchor member for each of these entities is determined by anchor member engine 203 as discussed below in connection with FIG. 15.

FIG. 15 is a flowchart of a method 1500 for determining anchor members in entities in accordance with an embodiment of the present disclosure.

Referring now to FIG. 15, in conjunction with FIGS. 1-12, in operation 1501, anchor member engine 203 of MDM system 101 identifies the “center member” of the entity corresponding to the record associated with the entity with the highest confidence score (discussed above). Such a member corresponds to the record having the most information.

In operation 1502, anchor member engine 203 of MDM system 101 identifies the “closest member” of the entity corresponding to the record with the attribute values that match most closely to the attribute values of the entity.

As stated above, in one embodiment, such a determination is performing using matching functionality (“matching mode” process). In one embodiment, the matching mode process involves comparing the attribute data of the members (e.g., name, address, date of birth) with the attribute data of the entity to determine if they are substantially similar to warrant a “match” based on mathematically derived statistical probabilities and complex weight tables. In one embodiment, anchor member engine 203 utilizes InfoSphere® master data management to perform such matching.

In operation 1503, anchor member engine 203 of MDM system 101 selects either the center member or the closest member of the entity as corresponding to the “anchor member” of the entity. For example, referring to FIG. 3, records 304 and 306 correspond to the anchor members of entities E1 301 and E2 302, respectively, as identified by the “*” placed next to the records in FIG. 3.

The records related to the entities may be updated or deleted. Furthermore, records related to the entities may be created. A discussion regarding managing the relationship between entities when such record transactions occur is provided below.

FIGS. 16A-16B are a flowchart of a method for managing the relationship been entities when record transactions involving creating, updating or deleting a record occur in accordance with an embodiment of the present disclosure. As discussed below, a relationship between entities is validated or invalidated based on an impact of the record transaction with the anchor member of one of these entities.

Referring to FIG. 16A, in conjunction with FIGS. 1-12, in operation 1601, record handler 204 of MDM system 101 determines whether MDM system 101 has received a record transaction from receiving component 104 involving creating, updating or deleting a record of an entity (e.g., entity 301) linked with another entity (e.g., entity 302).

If record handler 204 has not received such a record transaction, then record handler continues to monitor for the receipt of such a record transaction in operation 1601.

If, however, record handler 204 has received such a record transaction, then, in operation 1602, record handler 204 of MDM system 101 determines whether the record transaction involves a newly created record for a first entity (linked with a second entity), which corresponds to the anchor member for the first entity.

As previously discussed in connection with FIG. 4, when such a scenario occurs, in operation 1603, record handler 204 of MDM system 101 determines that the relationship between the first and second entities remains valid.

If, however, record handler 204 determines that the record transaction did not involve such a newly created record, then, in operation 1604, record handler 204 of MDM system 101 determine whether the record transaction involves a newly created record for the first entity (linked with a second entity) which is not made the anchor member of the first entity and where the original anchor member of the first entity remains the same.

If the record transaction involves a newly created record for the first entity (linked with a second entity) which is not made the anchor member of the first entity and where the original anchor member of the first entity remains the same, such as discussed above in connection with FIG. 5, then, in operation 1605, record handler 204 of MDM system 101 determines that the relationship between the first and second entities remains valid.

If, however, record handler 204 determines that the record transaction did not involve such a newly created record, then, in operation 1606, record handler 204 of MDM system 101 determines whether the record transaction (creating/updating/deleting record) involves an anchor member of the first entity (e.g., entity 301) linked to a second entity (e.g., entity 302) moving to a third entity (e.g., entity 601) and not being made an anchor member for the third entity.

In such a scenario, as discussed above in connection FIG. 6, in operation 1607, record handler 204 of MDM system 101 determines that the relationship between the first and second entities is no longer valid.

Referring now to FIG. 16B, in conjunction with FIGS. 1-12, if, however, record handler 204 determines that such a record transaction did not occur, then, in operation 1608, record handler 204 of MDM system 101 determines whether the record transaction (creating/updating/deleting record) involves an anchor member of the first entity (e.g., entity 301) linked to a second entity (e.g., entity 302) moving to a third entity (e.g., entity 601) and being made an anchor member for the third entity.

In such a scenario, as discussed above in connection FIG. 7, in operation 1609, record handler 204 of MDM system 101 moves the relationship created between the first and second entities to being between the second and third entities.

If, however, record handler 204 determines that such a record transaction did not occur, then record handler continues to monitor for the receipt of a record transaction from receiving component 104 involving creating, updating or deleting a record of an entity (e.g., entity 301) linked with another entity (e.g., entity 302) in operation 1601.

Additionally, relationships between entities need to be managed for the scenarios involving a manual unlink/link rule as discussed below in connection with FIG. 17.

FIG. 17 is a flowchart of a method 1700 for handling a manual unlink/link rule in accordance with an embodiment of the present disclosure.

Referring to FIG. 17, in conjunction with FIGS. 1-12, in operation 1701, record handler 204 of MDM system 101 determines whether a manual unlink rule to unlink the records of an entity has been received.

If a manual unlink rule has been received, then, in operation 1702, record handler 204 of MDM system 101 performs an entity split operation as discussed above in connection with FIGS. 9A-9B.

As stated above, in one embodiment, a manual unlink rule corresponds to a rule to hold records apart from both being members of the same entity. Such a manual unlink rule may be issued via REST API or Java® API. In one embodiment, such a rule may be issued by an administrator or an expert.

If, however, a manual unlink rule has not been received, then, in operation 1703, record handler 204 of MDM system 101 determines whether a manual link rule to link the records from different entities has been received.

If a manual link rule has been received, then, in operation 1704, record handler 204 of MDM system 101 performs an entity join operation as discussed above in connection with FIGS. 10A-10B.

As stated above, in one embodiment, a manual link rule corresponds to a rule to hold records together to become members of the same entity. Such a manual link rule may be issued via REST API or Java® API. In one embodiment, such a rule may be issued by an administrator or an expert.

If, however, a manual link rule has not been received, then record handler 204 of MDM system 101 continues to determine whether a manual unlink rule to unlink the records of an entity has been received in operation 1701.

In this manner, the principles of the present disclosure provide the means for managing the relationships between entities when record transactions involving creating, updating or deleting a record associated with such entities occur.

Furthermore, the principles of the present disclosure improve the technology or technical field involving master data management.

As discussed above, in master data management systems, a relationship could exist among records and/or entities, such as having a relationship between records (record-record relationship), between a record and an entity (record-entity relationship) and between entities (entity-entity relationship). One of the main aspects of master data management based solutions is managing relationships between parties including individuals, individuals and households, individuals and corporate entities, informal groups and organizations. Understanding relationships between parties and products as well as product hierarchies is critical for enterprises. A user can manage (create/update/delete) such relationships at the record level or at the entity level that is derived and persisted out of the record level. However, by managing (creating/updating/deleting) relationships at the record level, it may have an effect at the entity level. Currently, there is not a master data management based system for assessing such an effect at the entity level. That is, there is not currently a master data management based system for managing the relationships between entities (entity level relationships) as a result of create, update or delete transactions on the records associated with such entities.

Embodiments of the present disclosure improve such technology by resolving record level relationships at an entity level. “Resolving,” as used herein, refers to firmly determining the relationships among records associated with entities at the entity level. A “record,” as used herein, refers to information an organization needs to know about a particular person, location, product, supplier, business or other entity. An “entity,” as used herein, is the core element that is used for business processes in master data management. “Record level relationships at an entity level,” as used herein, refers to the relationships among records between entities. Furthermore, a unified view of relationships between entities is determined using composite rules on the underlying resolved record level relationships. “Composite rules,” as used herein, refer to the rules that determine which attributes (e.g., name, address) get persisted at the entity level. That is, composite rules determine which record-record relationships are persisted as entity-entity relationships. Additionally, an “anchor member” for each linked entity (e.g., first and second entities are linked together) is determined, where the entities are linked together based on the determined unified view of relationships between entities. An “anchor member,” as used herein, refers to the member (e.g., record) of the entity that is most representative of the entity. A record transaction involving creating, updating or deleting a record of an entity (e.g., first entity) linked with another entity (e.g., second entity) is received. The relationship between the linked entities is then validated or invalidated based on an impact of the record transaction with the anchor member of one of the linked entities. In this manner, relationships between entities are managed when record transactions involving creating, updating or deleting a record associated with such entities occur. Furthermore, in this manner, there is an improvement in the technical field involving master data management.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for managing relationships between entities in master data management based systems, the method comprising:
resolving record level relationships at an entity level;
determining a unified view of relationships between entities using composite rules on underlying resolved record level relationships;
determining an anchor member for both a first entity and a second entity being linked together based on said determined unified view of relationships between entities, wherein said anchor member corresponds to a record out of all records associated with an entity that is most representative of said entity;
receiving a record transaction involving a creating, updating or deleting of a record of one of said first and second entities; and
validating or invaliding a relationship between said first entity and said second entity based on an impact of said record transaction with said anchor member of said first entity or said second entity.

2. The method as recited in claim 1 further comprising:
invalidating said relationship between said first entity and said second entity in response to said anchor member of said first entity moving to a third entity and not being made an anchor member of said third entity.

3. The method as recited in claim 1 further comprising:
collapsing a relationship between records so that said records are replaced with a single record in response to said records being duplicated and associated with a same entity.

4. The method as recited in claim 1, wherein said anchor member corresponds to a record with a highest score indicating that said record has the most information.

5. The method as recited in claim 1, wherein said anchor member corresponds to a record with attribute values that most closely matches attribute values of said entity.

6. The method as recited in claim 1 further comprising:
validating said relationship between said first entity and said second entity in response to said record transaction involving a newly created record for said first entity becoming said anchor member of said first entity.

7. The method as recited in claim 1 further comprising:
moving said relationship between said first entity and said second entity to being between said second and a third entity in response to said record transaction involving said anchor member of said first entity moving to said third entity and being made said anchor member of said third entity.

8. The method as recited in claim 1 further comprising:
performing an entity split operation of said first entity in response to receiving a manual unlink rule thereby forming a new entity being associated with at least one record previously associated with said first entity.

9. The method as recited in claim 1 further comprising:
performing an entity join operation of said first entity and a fourth entity in response to receiving a manual link rule thereby joining said first entity and said fourth entity as corresponding to said first entity, wherein one or more records of said fourth entity are now associated with said first entity after said entity join operation.

10. A computer program product for managing relationships between entities in master data management based systems, the computer program product comprising one or more computer readable storage mediums having program code embodied therewith, the program code comprising programming instructions for:
resolving record level relationships at an entity level;
determining a unified view of relationships between entities using composite rules on underlying resolved record level relationships;
determining an anchor member for both a first entity and a second entity being linked together based on said determined unified view of relationships between entities, wherein said anchor member corresponds to a record out of all records associated with an entity that is most representative of said entity;
receiving a record transaction involving a creating, updating or deleting of a record of one of said first and second entities; and
validating or invaliding a relationship between said first entity and said second entity based on an impact of said record transaction with said anchor member of said first entity or said second entity.

11. The computer program product as recited in claim 10, wherein the program code further comprises the programming instructions for:
invalidating said relationship between said first entity and said second entity in response to said anchor member of said first entity moving to a third entity and not being made an anchor member of said third entity.

12. The computer program product as recited in claim 10, wherein the program code further comprises the programming instructions for:
collapsing a relationship between records so that said records are replaced with a single record in response to said records being duplicated and associated with a same entity.

13. The computer program product as recited in claim 10, wherein said anchor member corresponds to a record with a highest score indicating that said record has the most information.

14. The computer program product as recited in claim 10, wherein said anchor member corresponds to a record with attribute values that most closely matches attribute values of said entity.

15. The computer program product as recited in claim 10, wherein the program code further comprises the programming instructions for:
validating said relationship between said first entity and said second entity in response to said record transaction involving a newly created record for said first entity becoming said anchor member of said first entity.

16. The computer program product as recited in claim 10, wherein the program code further comprises the programming instructions for:
moving said relationship between said first entity and said second entity to being between said second and a third entity in response to said record transaction involving said anchor member of said first entity moving to said third entity and being made said anchor member of said third entity.

17. The computer program product as recited in claim 10, wherein the program code further comprises the programming instructions for:
performing an entity split operation of said first entity in response to receiving a manual unlink rule thereby forming a new entity being associated with at least one record previously associated with said first entity.

18. The computer program product as recited in claim 10, wherein the program code further comprises the programming instructions for:
performing an entity join operation of said first entity and a fourth entity in response to receiving a manual link rule thereby joining said first entity and said fourth entity as corresponding to said first entity, wherein one or more records of said fourth entity are now associated with said first entity after said entity join operation.

19. A system, comprising:
a memory for storing a computer program for managing relationships between entities in master data management based systems; and
a processor connected to said memory, wherein said processor is configured to execute program instructions of the computer program comprising:
resolving record level relationships at an entity level;
determining a unified view of relationships between entities using composite rules on underlying resolved record level relationships;
determining an anchor member for both a first entity and a second entity being linked together based on said determined unified view of relationships between entities, wherein said anchor member corresponds to a record out of all records associated with an entity that is most representative of said entity;
receiving a record transaction involving a creating, updating or deleting of a record of one of said first and second entities; and
validating or invaliding a relationship between said first entity and said second entity based on an impact of said record transaction with said anchor member of said first entity or said second entity.

20. The system as recited in claim 19, wherein the program instructions of the computer program further comprise:
invalidating said relationship between said first entity and said second entity in response to said anchor member of said first entity moving to a third entity and not being made an anchor member of said third entity.
